(19) United States
(12) Patent Application Publication
(10) Pub. No.: US 2010/0213046 A1
(43) Pub. Date: Aug. 26, 2010

(54) Titania nanotube arrays, methods of manufacture, and photocatalytic conversion of carbon dioxide using same

(75) Inventors: Craig A. Grimes, Boalsburg, PA (US); Oomman K. Varghese, State College, PA (US); Maggie Paulose, State College, PA (US)

Correspondence Address: John A. Parrish, Suite 300, Two Bala Plaza, Bala Cynwyd, PA, 19004, US

(73) Assignee: The Penn State Research Foundation, University Park, PA (US)

(21) Appl. No.: 12/655,753

(22) Filed: Jan. 5, 2010

Related U.S. Application Data
(60) Provisional application No. 61/204,389, filed on Jan. 6, 2009.

(51) Int. Cl. C01B 31/00; B01J 27/24; B01J 21/18; C01B 3/00

(52) U.S. Cl. 204/157.47; 502/200; 502/182; 204/157.52; 977/762; 977/773; 977/775

(57) ABSTRACT

Nitrogen-doped titania nanotubes exhibiting catalytic activity on exposure to any one or more of ultraviolet, visible, and/or infrared radiation, or combinations thereof are disclosed. The nanotube arrays may be co-doped with one or more nonmetals and may further include co-catalyst nanoparticles. Also, methods are disclosed for use of nitrogen-doped titania nanotubes in catalytic conversion of carbon dioxide alone or in admixture with hydrogen-containing gases such as water vapor and/or other reactants as may be present or desirable into products such as hydrocarbons and hydrocarbon-containing products, hydrogen and hydrogen-containing products, carbon monoxide and other carbon-containing products, or combinations thereof.

### CROSS REFERENCE TO RELATED APPLICATIONS

The present application claims the benefit of U.S. Provisional Application Ser. No. 61/204,389, filed on Jan. 7, 2009, incorporated herein by reference in its entirety.

### FIELD OF THE INVENTION

The disclosed invention generally relates to nitrogen-doped titania nanotube arrays, methods of manufacturing the arrays, and processes for catalytically converting carbon dioxide to value added reaction products.

### BACKGROUND OF THE INVENTION

The rapid increase in the level of anthropogenic carbon dioxide is a matter of great concern. While discussions have begun on means to reduce carbon dioxide emissions, it is apparent that atmospheric carbon dioxide concentrations will continue to increase for the foreseeable future due to fossil fuel consumption. Suggestions have been made to sequester carbon dioxide, although the ability to store several billion tons of carbon emitted in the form of carbon dioxide every year is questionable as are the environmental consequences. Recycling of carbon dioxide via conversion into high energy-content fuel suitable for use in the existing hydrocarbon-based energy infrastructure is an option. However, recycling of carbon dioxide is unfortunately energy intensive.

The art has used oxide semiconductor particles and non-oxide semiconductor particles in attempts to reduce carbon dioxide to organic compounds such as formic acid, formaldehyde, methanol and methane.

Titanium dioxide (TiO₂) is a wide bandgap semiconductor associated with high photoactivity, thermal and chemical stability, low cost and nontoxicity. As a result of these favorable characteristics, titanium dioxide has been extensively used in an array of reactions including selective oxidation and reduction, condensation, polymerization, perfluorination, photodegradation, and solar power.

Titania occurs primarily in three crystalline phases with bandgaps ranging from 3.4 eV to 3.0 eV at room temperature, corresponding to light absorption in the wavelength range below 365 nanometers (nm) to 413 nm. When exposed to light of equal or greater energy than the bandgap (i.e., ultraviolet light), charge transfer from the valence band to the conduction band occurs, creating an electron-hole pair which can either recombine or react with adsorbates on the exposed surface of the titania. While this has been typically seen in the case of splitting water into oxygen and hydrogen and in most photooxidative processes, the commercial use of titania in photocatalytic processes has been largely frustrated by the fact that ultraviolet radiation makes up less than 5% of the sunlight that reaches the Earth.

Titanium dioxide has also been considered for use in photocatalytic processes involving the conversion of carbon dioxide but, as with other photocatalytic processes involving use of titania, such processes have historically suffered from low carbon dioxide conversion rates due to their reliance on ultraviolet illumination. These limitations are evident in the art; for example, a total hydrocarbon (methane, ethylene and ethane) generation rate of about 1.7 μl/hr·g under xenon lamp illumination has been obtained in the art with copper-loaded titania nanoparticles dispersed in CO₂-pressurized water. Titania pellets (100 g) also have been used in the art to obtain a conversion rate of about 0.25 μmol/hr of methane from moist carbon dioxide under monochromatic ultraviolet (253.7 nm wavelength) illumination. In addition, a rate of generation of 4.1 μmol/hr·g of methane from a mixture of hydrogen (90%), water and carbon dioxide combination has been reported in the art using ultraviolet illumination at wavelengths of 254 nm and of 365 nm. The use of sol-gel-derived titania multilayer films inside a copper tube has been reported in the art to achieve a total hydrocarbon product (CO, CH₄, C₂H₄ and C₂H₆) formation rate of about 3.2 nmol/cm²·hr under ultraviolet illumination of 2.4 mW/cm².

A need therefore exists for photocatalysts capable of accessing and using the energy contained in a broader spectrum of electromagnetic radiation as compared to titania-based photocatalysts that have been previously demonstrated, and a need exists for methods capable of converting carbon dioxide into value added reaction products at increased efficiencies.

### BRIEF DESCRIPTION OF THE DRAWINGS

Referring to the figures wherein like numbers refer to like elements:

FIG. 1 shows diffuse reflectance spectra plotted as K-M function F(R) indicating nitrogen doping;

FIG. 2 schematically illustrates a closed end type nanotube array membrane in accordance with the invention;

FIG. 3 schematically illustrates a flow-through type nanotube array membrane in accordance with the invention;

FIG. 4 graphically illustrates photocatalytic conversion rate of carbon dioxide to various hydrocarbons for various nitrogen-doped titania nanotube array films under direct sunlight;

FIG. 5 graphically illustrates glancing angle x-ray diffraction patterns of 60 μM long platinum sensitized nitrogen-doped nanotube array samples annealed at 460° C. and 600° C.;

FIG. 6 graphically illustrates photocatalytic conversion rates of carbon dioxide to hydrogen and carbon monoxide for various nitrogen-doped nanotube array films under direct sunlight;

FIG. 7 graphically illustrates photocatalytic conversion rates of nitrogen-doped titania nanotube arrays sensitized with both Cu and Pt nanoparticles under sunlight illumination.

FIG. 8 graphically illustrates total yield of products from carbon dioxide conversion for a nitrogen-doped nanotube array under direct sunlight where the UV component of the sunlight is removed by a high-pass filter.

### SUMMARY OF THE INVENTION

Disclosed herein are catalysts that are photosensitive to ultraviolet, visible and/or infrared radiation comprised of nitrogen-doped titania nanotubes of the formula TiNₓO₂₋ₓ wherein 0≦x≦1, preferably 0.01≦x≦1, with nanoparticles of one or more metal and/or metal oxide co-catalysts deposited on one or more surfaces of the nitrogen-doped titania nanotubes. The co-catalyst may be selected from a group consisting of Ag, As, Au, Bi, Cd, Co, Cu, CuO, Cu₂O, Fe, Ga, Ge, In, Ir, Ni, Pb, Pd, Pt, Rh, Sb, Si, Sn, Ta, Ti, W, Zn or mixtures thereof (hereinafter referred to as the “Co-catalyst Group”). The nitrogen-doped titania nanotubes may alternatively be comprised of titania or titania and one or more metals and/or metal oxides with the formula Ti_{1-y}M_{y}O₂, where 0≦y≦1 and where M is selected from the Co-catalyst Group, preferably Cu; with nanoparticles of one or more metals and/or metal oxides selected from the Co-catalyst Group deposited on one or more surfaces of the nitrogen-doped titania nanotubes. The nitrogen-doped titania nanotubes optionally may be co-doped with one or more non-metals selected from a group consisting of B, C, F, I, P, S or mixtures thereof.

In another aspect, a method for forming nitrogen-doped titania nanotubes of the formula TiNₓO₂₋ₓ, where 0≦x≦1 such as self-organized nitrogen-doped titania nanotubes of the formula TiNₓO₂₋ₓ, where 0≦x≦1. The method entails anodizing a titanium substrate in an electrolyte comprising a fluoride ion source, a chloride ion source, or combinations thereof and a nitrogen source to form an amorphous nitrogen-doped titania nanotube array; heating the amorphous nitrogen-doped titania nanotube array at a temperature, atmosphere and time effective to increase the crystallinity and catalytic efficiency of the nitrogen-doped titania nanotube array; and, depositing nanoparticles of one or more metals and/or metal oxides selected from the Co-catalyst Group on one or more surfaces of the nanotubes. The titanium substrate upon which the nitrogen-doped titania nanotubes are formed may be titanium alone or titanium and one or more metals and/or metal oxides selected from the Co-catalyst Group. The nitrogen-doped titania nanotubes may also alternatively be co-doped with one or more nonmetals selected from a group consisting of B, C, F, I, P, S or mixtures thereof. Preferably, the nitrogen-doped titania nanotubes are open-ended, flow-through nitrogen-doped titania nanotubes.

In yet a further aspect, a method for photocatalytically converting carbon dioxide into useful reaction products entails introducing a reactant gas such as carbon dioxide alone, mixtures of carbon dioxide and hydrogen-containing gases such as water vapor, and mixtures of carbon dioxide, hydrogen-containing gases such as water vapor and other reactants as may be present or desirable, into a reaction chamber in the presence of any one or more of the photocatalysts disclosed herein and in the presence of any one or more of ultraviolet, visible and/or infrared radiation, preferably derived from sunlight, to generate reaction products in the form of, for example, hydrocarbons, hydrogen, carbon monoxide, mixtures thereof, and other products as may be present or desirable. The photocatalyst is a nitrogen-doped titania nanotube array of the formula TiNₓO₂₋ₓ wherein 0≦x≦1, with nanoparticles of one or more metal and/or metal oxides selected from the Co-catalyst Group deposited on one or more of the surfaces of the nitrogen-doped titania nanotubes. The nitrogen-doped titania nanotubes may be titanium alone as the cation or titanium and one or more metals as cations and/or metal oxides selected from the co-catalyst group. The nitrogen-doped titania nanotubes may also be co-doped with one or more nonmetals selected from a group consisting of B, C, F, I, P, S or mixtures thereof. The nanotube photocatalyst may be in the form of a closed-end type nanotube array, an open-ended flow-through type nanotube array, or combinations thereof.

Advantageously, the nitrogen-doped titania nanotube arrays of the invention may achieve significantly greater photocatalytic activity than the art, such as has been obtained by use of ultraviolet illumination in laboratory settings. Accordingly, conversion of carbon dioxide into value added reaction products may be achieved at improved efficiencies with the use of the nitrogen-doped titania nanotube arrays disclosed herein.

Having summarized the invention, the invention may be further understood by reference to the following detailed description and non-limiting examples.

### DETAILED DESCRIPTION OF THE INVENTION

Disclosed herein are nitrogen-doped titania nanotube arrays, methods of manufacturing the arrays, and processes for catalytically converting carbon dioxide to value added reaction products. It has been discovered that incorporating nitrogen into the nanotubes in-situ during anodization, with a subsequent heat treatment, results in crystallized titania nanotubes with N (2p) states formed above the titania valence band, which shifts the absorption edge of titania to about 540 nm. Previously, the TiO₂ bandgap, which ranges from 3.0 eV and 3.4 eV for the three mineral forms, restricted excitation wavelengths to less than about 400 nm.

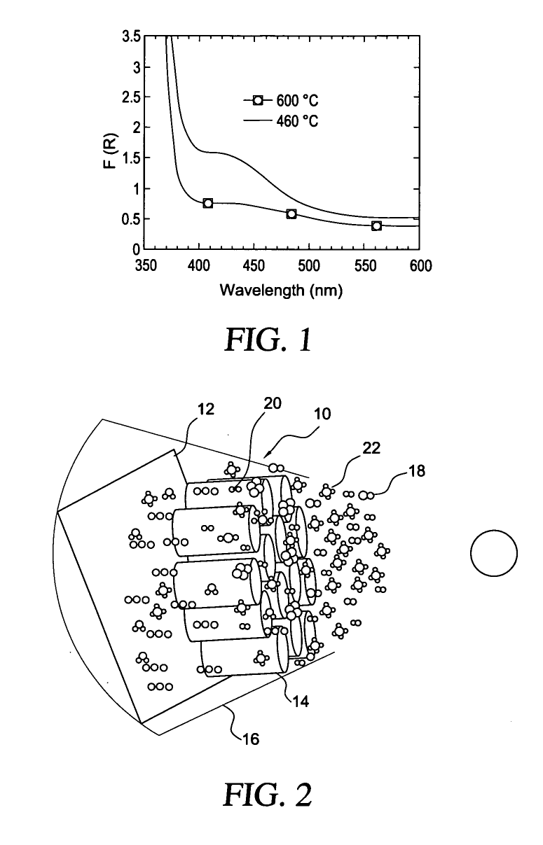

FIG. 1 graphically illustrates absorption spectra of nitrogen-doped titania nanotubes annealed at 460° C. and 600° C. The diffuse reflectance spectra of nanotube array samples of nearly the same thickness (≈130 μm) annealed at 460° C. and 600° C. were measured using a Perkin-Elmer Lambda 950 spectrophotometer equipped with an integrating sphere. The diffuse reflectance spectra expressed in terms of the Kubelka-Munk function F(R) is shown in FIG. 1. Nitrogen doping in the samples is indicated by the hump above the intrinsic titania absorption edge at 400 nm, which extends up to 540 nm. The 600° C. annealed samples exhibit lower light absorption in the visible region indicating a lower level of nitrogen doping, a result confirmed via X-ray photoelectron spectroscopy.

As a result of the bandgap shift caused by replacement of oxygen with nitrogen within the titania lattice, the nitrogen-doped titania nanotubes can use the visible portion in addition to the ultraviolet portion of the solar spectrum to photocatalytically increase the conversion rate of carbon dioxide to hydrocarbon. The rate of hydrocarbon production obtained using outdoor sunlight with the nitrogen-doped titania nanotubes is significantly greater than that previously obtained using ultraviolet illumination alone.

Although specific reference is made herein below to outdoor sunlight, it should be noted that the present invention is not so limited. Artificial light sources that have an irradiance spectrum in the ultraviolet, visible, infrared spectrum or combinations thereof may also be used such as for indoor applications and the like.

### Photocatalyst Composition

The photocatalyst disclosed herein include nitrogen-doped titania nanotubes of the formula TiNₓO₂₋ₓ wherein 0≦x≦1, preferably 0.01≦x≦1, more preferably 0.001≦x≦1.

The nitrogen-doped titania nanotubes may optionally have on one or more surfaces thereof one or more metal and/or metal oxide nanoparticles selected from the Co-catalyst Group. As used herein, the term “nanoparticles” refers to particulate materials that have at least one dimension less than about 100 nm. The co-catalyst may be used to achieve greater catalytic activity and/or photosensitivity to ultraviolet, visible and/or infrared radiation.

In another aspect, the nitrogen-doped titania nanotubes may include titanium alone as the cation or titanium and one or more metals as cations and/or metal oxides selected from the Co-catalyst Group as cations, having the formula Ti_{1-y}M_{y}O₂ where 0≦y≦1 and where M is one or more metals and/or metal oxides selected from the Co-catalyst Group, preferably Cu; with or without the deposition of one or more metal and/or metal oxide nanoparticles selected from the Co-catalyst Group on one or more surfaces of the nanotubes.

The nitrogen-doped titania nanotubes may also be co-doped with one or more nonmetals selected from a group consisting of B, C, F, I, P, S or mixtures thereof.

The nanotube photocatalyst may be in the form of a closed end type nanotube array, an open-ended flow-through type nanotube array, or combinations thereof.

### Manufacture of Photocatalyst

Nitrogen-doped nanotube arrays of the formula TiNₓO₂₋ₓ where 0≦x≦1 may be made by anodic oxidation of a substrate comprising titanium in an electrolyte solution that includes a fluoride ion source, a chloride ion source or mixtures thereof, and a nitrogen source.

The substrate may be titanium alone or may be titanium with one or more metals, as well as titanium with combinations of metals and/or metal oxides selected from the co-catalyst group, preferably Cu, and may be made by melt forming, sputtering, vapor deposition, and/or other such methods as are known to those skilled in the art.

Suitable fluoride ion sources and chloride ion sources include, but are not limited to HF, HCl, KF, NH₄F and mixtures thereof. The electrolyte solution has sufficient amounts of one or more of fluoride ions and chloride ions or mixtures thereof to etch the titanium substrate during anodization. The nitrogen source may be introduced into the electrolyte solution in the form of a fluoride salt, a chloride salt or mixtures thereof. Suitable salts include, without limitation, ammonium fluoride (NH₄F), ammonium difluoride, tetrabutyl-ammonium fluoride (Bu₄NF), benzyltrimethyl ammonium fluoride (BnMe₃NF), ammonium chloride, and mixtures thereof, preferably ammonium fluoride. Other nitrogen sources that may be used include ammonia, nitrogen-containing gases and nitrogen available from the atmosphere.

Where ammonium fluoride (NH₄F) is employed in an electrolyte solution, the molarity (M) of the ammonium fluoride in the electrolyte solution may be about 0.003M to about 0.3M, preferably about 0.01M to about 0.25M, more preferably about 0.02M to about 0.2M. As an example, the electrolyte may include ethylene glycol, 0.09M ammonium fluoride and 2% water. Where gaseous nitrogen is employed as a source of nitrogen, the gaseous nitrogen may be introduced into the electrolyte solution during anodization by bubbling nitrogen gas directly into the electrolyte solution.

Polar solvents such as ethylene glycol in the electrolyte may be employed alone or in admixture with other polar solvents as the electrolyte solvent. Other polar solvents that may be employed alone or in admixture with ethylene glycol as electrolyte solvent include but are not limited to formamide (FA), dimethyl sulfoxide (DMSO), dimethylformamide (DMF), and N-methylformamide (NMF), diethylene glycol and mixtures thereof. The electrolyte solvent may include water in an amount of up to about 5 percent by volume based on the total volume of the electrolyte solution.

Anodization is well known in the art and determining the particular conditions is well within the skill of those in the art. Anodization is employed to achieve titania nanotubes that preferably have ultrahigh surface area and are vertically oriented. The nanotubes typically have a high aspect ratio of about 100 to about 10,000 and length of about 0.2 μm to about 1000 μm. The length of the nanotubes is a function of residence time and voltage during anodization in a given electrolyte composition.

Anodization may be performed as disclosed in Paulose et al., J. Phys. Chem. B 2006, 110, 16179, the teachings of which are incorporated herein by reference in their entirety. Anodization may be performed over a wide range of anodization currents and voltages. Generally, the titanium substrate may be anodized at about 5 volts (V) to about 120 V, preferably about 10 V to about 90 V, more preferably about 15 V to about 80 V, at temperatures of about −5° C. to about 100° C., preferably about 10° C. to about 50° C.

The pore size diameter of the nitrogen-doped titania or titania nanotubes may be varied by manipulating the anodization voltage and by varying the acid content of the electrolyte during anodization of the titanium substrate. Generally, smaller pore sizes may be achieved by use of lower anodization voltages. Also, pore size may be manipulated by varying the concentration of acid in the electrolyte. Typically, anodization voltages of about 8 V to about 120 V at 0.003M to 0.3M acid content may be used to produce pore sizes of about 20 nm to about 250 nm in the nanotubes. Nanotubes with smaller pore sizes may enable restrictive flow and provide more surface area for reaction with and conversion of carbon dioxide, either alone or in the presence of water (liquid or vapor) and/or other gases.

Anodization of the titanium substrate in the fluorine and/or chlorine ion-containing electrolyte with the nitrogen source typically results in the production of amorphous nitrogen-doped nanotube arrays. To maintain the titania stoichiometry and reduce lattice defects, the process further includes a heat treatment to increase crystallinity. For example, the nitrogen-doped titania nanotube arrays may be crystallized by annealing at elevated temperatures in flowing oxygen, air and/or other gases such as hydrogen sulfide. Annealing may be performed in a tube furnace or the like. The temperature, atmosphere and time for annealing may be varied, for example, to minimize loss of nitrogen from the lattice structure of nitrogen-doped titania nanotubes, or to add one or more co-dopants nonmetals selected from a group consisting of B, C, F, I, P, S or mixtures thereof. For example, the atmosphere may include hydrogen sulfide to replace some of the oxygen atom sites with sulfur. Alternatively, the co-dopant can be introduced in the electrolyte solution. Nitrogen-doped titania nanotubes, for example, may be annealed at about 280° C. to about 700° C., preferably about 460° C. to about 600° C. for about 0.5 hours to about 8 hours, preferably about 1 hour to about 5 hours.

The resulting heat-treated nitrogen-doped nanotube arrays have the general formula of TiNₓO₂₋ₓ, wherein x is 0≦x≦1, preferably 0.01≦x≦1, more preferably 0.001≦x≦1.

The nitrogen doped nanotubes may be co-doping with non-metals such as B, C, F, I, P, S or mixtures thereof. Co-doping may be performed in several alternative methods. For example, a non-metal dopant bearing compound suitable for providing any one or more non-metals such as B, C, F, I, P, S may be included in the anodization electrolyte. Alternatively, the nanotubes may be heat treated in an atmosphere that includes any one or more of B, C, F, I, P, S. Yet another alternative includes ion implantation of any one or more of B, C, F, I, P, S into the nanotubes.

Where deposition of one or more metals, metal oxides or combinations thereof selected from the co-catalyst group is desired on one or more surfaces of the nanotubes, the nanoparticles may be formed on those surfaces by techniques known to those skilled in the art, such as but not limited to sputter deposition, vapor deposition, solution deposition.

The co-catalysts may be in the form of nanoparticles that may have interparticle spacings on the surface of the nanotubes of about 10% to about 200% of the nanoparticle diameter and may have a thickness of about 5% to 200% of the nanotube wall thickness. The co-catalyst nanoparticles may be deposited to surround the openings of the nanotubes or may be distributed over the entire surface of the nanotube array, including interior surfaces, exterior surfaces or both of the nanotubes.

Nanotubes employed as photocatalysts may have the shape of laboratory test tube where one end of the nanotube is open and the other end of the nanotube is closed. The closed end of the nanotubes may be opened by means such as concentrated hydrofluoric acid, concentrated sulfuric acid or mixtures thereof, or by ion milling to yield a flow-through nanotube array where both ends of the nanotubes are open.

Arrays of nanotubes such as nitrogen-doped titania nanotubes may also be separated from a substrate such as a titanium substrate by the voltage-assisted separation method. In this method, the annealed nanotubes are maintained in a conducting electrolyte such as the ethylene glycol electrolyte employed during anodization of the titanium film substrate while a voltage of the same or opposite polarity as used for anodization is applied between the titanium substrate and a platinum electrode. The separated membranes are washed in water and may be dried. In this manner, the nitrogen-doped nanotube arrays may be used in batch processes as well as in continuous flow-through processes.

Generally, nanotube arrays of the formula Ti_{1-y}M_{y}O₂ where 0≦y≦1 and where M is a co-catalyst of any one of As, Ag, Au, Bi, Cd, Co, Cu, CuO, Cu₂O, Fe, Ga, Ge, In, Ir, Ni, P, Pb, Pd, Pt, Rh, Sb, Si, Sn, Ta, Tl, W, Zn and combinations thereof, preferably Cu may be made by first forming an alloy of Ti and M such as by melt forming, sputtering, vapor deposition and the like. The alloy then may be anodized to incorporate one or more of the M co-catalysts into the nanotube.

Where M is Cu, nanotubes of the formula Ti_{1-y}Cu_{y}O₂, 0≦y≦1 such as compositionally-graded Ti—Cu—O nanotubes may be synthesized by anodizing a Cu—Ti metal substrate such as a Cu—Ti foil that may have a compositional gradient. The Cu—Ti foils typically have a thickness of about 250 μm and are cleaned such as with ethanol prior to anodization. Anodization may be performed in ethylene glycol electrolyte that includes about 0.3 M ammonium fluoride (NH₄F) in about 2 vol % water at about 55 V DC at about 20° C. according to the procedure disclosed in Paulose et al., J. Phys. Chem. B 2006, 110, 16179. Anodization may be performed in a two-electrode electrochemical cell connected to a DC power supply where platinum foil is used as the counter electrode. Anodization, may be performed at a 5V to about 80 V at about 5° C. to about 100° C. Anodization current may be monitored by a Keithley (model 2000) digital multimeter interfaced with a computer.

The nanotubes may be annealed at about 460° C. to about 600° C. for about 0.5 hours to about 8 hours, preferably about 1 hour to about 5 hours.

### Use of Photocatalyst in Photocatalytic Conversion

Any one or more of the photocatalysts such as those described above may be used alone or in combination to effect photocatalytic conversion of any one or more of carbon dioxide alone, mixtures of carbon dioxide and hydrogen-containing gases such as water vapor, and mixtures of carbon dioxide, hydrogen-containing gases such as water vapor and other reactants as may be present or desirable to generate reaction products in the form of, for example, hydrocarbons, hydrogen, carbon monoxide, mixtures thereof, and other products as may be present or desirable. Hydrocarbon reaction products may include but are not limited to alkanes such as methane, ethane, propane, butane, pentane, hexane and mixtures thereof, olefins such as ethylene, propylene, butylene, pentene, hexane or mixtures thereof, and branched paraffins such as isobutene, 2,2-dimethyl propane, 2-methyl butane, 2,2-dimethyl butane, 2-methyl pentane, 3-methyl pentane and mixtures thereof. The reaction products may be further processed and refined to yield hydrogen-based fuels and other products, synthesis gas (“syngas”) and derivatives of syngas (which may include hydrocarbon-based fuels and other products), and the like.

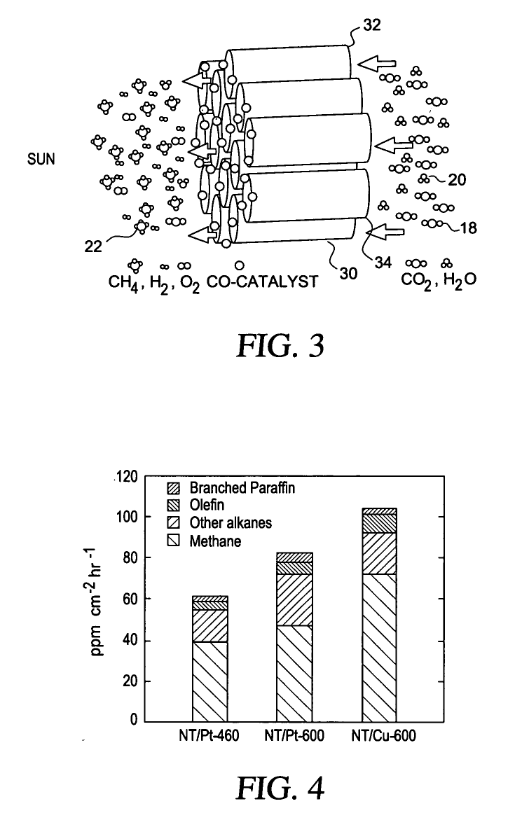

The methods disclosed herein for photocatalytic conversion may be performed by batch processing, continuous flow-through processing or combinations thereof. While closed end type nanotube arrays such as shown in FIG. 2 are suitable in each type of processing, it is preferred to employ open-end, flow-through type nanotube arrays such as shown in FIG. 3 in continuous processing of reactant input gases. Both batch and continuous flow-through processes may be employed with gaseous carbon dioxide sources, as well as supercritical carbon dioxide sources.

Reactant input gases to be converted as described herein may include any one or more of carbon dioxide alone, mixtures of carbon dioxide and hydrogen-containing gases such as water vapor, and mixtures of carbon dioxide, hydrogen-containing gases such as water vapor and other reactants as may be present or desirable. For example, and without limitation, an input gas may include carbon dioxide alone to yield a product that includes a mixture of carbon monoxide and oxygen. Where the input gas is a mixture of carbon dioxide and water vapor, carbon dioxide may be present in the mixture in an amount of less than 100%, with the remainder in the form of water vapor to yield a product that includes any one or more of hydrocarbons, hydrogen-containing gases and compounds, and/or carbon-containing gases and compounds.

FIG. 2 shows a closed end type nanotube array 10. The array includes a substrate 12 such as titanium upon which are located nanotubes 14 such as nitrogen-doped titania nanotubes. In use, array 10 is oriented to receive light 16 such as sunlight to photocatalytically convert an input gas such as a mixture of carbon dioxide 18, either alone or in the presence of water (liquid or vapor) 20 or other gases to reaction products 22 such as hydrocarbons, hydrogen and carbon monoxide. Hydrocarbon reaction products may include but are not limited to alkanes such as methane, ethane, propane, butane, pentane, hexane and mixtures thereof, olefins such as ethylene, propylene, butylene, pentene, hexane and mixtures thereof and branched paraffins such as isobutene, 2,2-dimethyl propane, 2-methyl butane, 2,2-dimethyl butane, 2-methyl pentane, 3-methyl pentane and mixtures thereof.

FIG. 3 shows a flow-through type nanotube array in the form of membrane 30. Membrane 30 includes nanotube array 32 having open ends 34 to enable continuous flow-through of an input gas such as a mixture of carbon dioxide 18 and water vapor 20 through membrane 30. Flow-through type arrays advantageously may be employed to maximize the rate of generation of reaction products where the reaction products are separated from the input gas. Flow-through type arrays also advantageously may minimize accumulation of reaction products on the active reaction sites on the surfaces of the nanotubes.

In use, membrane 30 may be exposed to light 16 such as sunlight to photocatalytically convert an input gas such as carbon dioxide 18, either alone or in the presence of water (liquid or vapor) 20 and/or additional gases, to reaction products 22 such as hydrocarbons, hydrogen and carbon monoxide. Hydrocarbon reaction products may include but are not limited to alkanes such as methane, ethane, propane, butane, pentane, hexane and mixtures thereof, olefins such as ethylene, propylene, butylene, pentene, hexene and mixtures thereof and branched paraffins such as isobutene, 2,2-dimethyl propane, 2-methyl butane, 2,2-dimethyl butane, 2-methyl pentane, 3-methyl pentane and mixtures thereof. When employed in photocatalytic conversion of carbon dioxide, either alone or in the presence of water (liquid or vapor) and/or additional gases, nanotube arrays such as any one or more of closed-end type nanotube arrays, open-end flow-through type nanotube arrays, or combinations thereof may be loaded into or pass through a reaction cell that has a window for admitting ultraviolet, visible and/or infrared radiation, or combinations thereof, preferably deriving from sunlight.

Where open-ended flow-through type nanotube arrays are employed, those arrays may be physically supported, for example, without limitation, on a mesh screen or the like. However, flow-through type, nitrogen-doped nanotube arrays may be unsupported during use. The arrays when used as a membrane may be planar or may be cylindrically shaped or in any other geometry or configuration as may be desired for different applications.

Photocatalytic conversion of an input reactant gas such as any one or more of carbon dioxide alone, mixtures of carbon dioxide and hydrogen-containing gases such as water vapor, and mixtures of carbon dioxide, hydrogen-containing gases such as water vapor and other reactants as may be present or desirable, may be performed by admitting the input reactant gas into a reaction cell in the presence of one or more photocatalysts, and then admitting ultraviolet, visible and/or infrared light, or combinations thereof, preferably deriving from sunlight, into the reaction cell. The photocatalyst employed may include any one or more of TiNₓO₂₋ₓ, where 0≦x≦1 optionally bearing co-catalysts and Ti_{1-y}M_{y}O₂ where 0≦y≦1 optionally bearing co-catalysts and where TiNₓO₂, is optionally co-doped with one or more non-metals such as B, C, F, I, P, S or mixtures thereof and Ti_{1-y}M_{y}O₂ is optionally doped with one or more nonmetals such as B, C, F, I, P, S, N or mixtures thereof, preferably N. Co-catalysts that may be employed include but are not limited to any one or more of As, Ag, Au, Bi, Cd, Co, Cu, CuO, Cu₂O, Fe, Ga, Ge, In, Ir, Ni, P, Pb, Pd, Pt, Rh, Sb, Si, Sn, Ta, Tl, W, Zn and mixtures thereof. Reaction cells for use in such manner generally include one or more inlets and outlets for admitting input gases into the cell and a window for admitting light into the cell. Input gases may be admitted as a mixture or may be admitted independently for mixing within the reaction cell. Preferably, the input reactant gases may be admitted as a mixture of carbon dioxide and hydrogen-containing gases such as water vapor.

Concentrators such as lenses, mirrors and the like, and/or other conventional optical devices and methods, may be used to distribute, separate, and/or increase the intensity of ultraviolet, visible and/or infrared radiation, or combinations thereof, onto the nanotube arrays present in the cell to enable use of higher input flow rates of the reactant gas(es) to enable increased generation rates of reaction products such as, for example, hydrocarbons, hydrogen, carbon monoxide, mixtures thereof, and other products as may be present or desirable. Hydrocarbon reaction products that may be generated include but are not limited to alkanes such as methane, ethane, propane, butane, pentane, hexane and mixtures thereof, olefins such as ethylene, propylene, butylene, pentene, hexene and mixtures thereof, and branched paraffins such as isobutene, 2,2-dimethyl propane, 2-methyl butane, 2,2-dimethyl butane, 2-methyl pentane, 3-methyl pentane and mixtures thereof.

The reaction products generated in conversion of mixtures of input gases may be analyzed by known methods such as gas chromatography equipped with flame ionization, pulsed discharge helium ionization, and thermal conductivity detectors.

### EXAMPLES

The invention is further illustrated below by reference to the following non-limiting examples.

In the following examples, anodization was performed in a two-electrode configuration with titanium substrate as the working electrode and platinum substrate as the counter electrode under constant potential at room temperature (20° C.). A direct power supply (Agilent E3612A) was used as the voltage source to drive the anodization and a multimeter (Keithly 2000 model) was used to measure the resulting anodization current. Reaction products are analyzed by use of a Shimadzu (GC-17A) gas chromatograph equipped with flame ionization (FI) and thermal conductivity (TC) detectors. FI detectors enable detection of hydrocarbons and the TC detector was used to detect other reaction products.

### Example 1

### Preparation of Annealed, Nitrogen-Doped Titania Nanotube Array Sensitized with Platinum Nanoparticle Co-Catalysts

Nitrogen-doped TiO₂ nanotube arrays of the formula TiNₓO₂₋ₓ, where x is 0.023 and that measured 35 μm in length were made by anodizing a titanium substrate in an ethylene glycol electrolyte that included 0.09M ammonium fluoride in 2 percent by volume water at 55V DC for a time period of 8 hours. The titanium substrate had a thickness of 250 μm (Sigma Aldrich, 99.7% purity) and was cleaned in ethanol and dried in nitrogen prior to anodization.

The nitrogen-doped titania nanotube arrays were annealed at 460° C. in air for 6 hours. Co-catalysts of Pt nanoparticles were deposited onto the annealed nitrogen-doped titania nanotube arrays by DC sputter deposition of platinum nanoparticles (DC power 1.8 W/cm², pressure 20 mTorr, 5 cm distance between target and sample, deposition duration 13 seconds).

High-resolution transmission electron microscope (HRTEM) examination of the platinum-coated annealed nitrogen-doped titania nanotube array showed nanoscale platinum islands that measure up to 40 nm attached to the nanotube walls.

The total nitrogen concentration in the nanotubes as determined by XPS was 0.75 atom percent. The platinum-sensitized, nitrogen-doped titania nanotube arrays annealed at 460° C. are hereinafter referred to as NT/Pt460.

### Example 1A

The procedure of example 1 was followed except that the nitrogen-doped titania nanotube arrays were annealed at 600° C. in air. The total nitrogen concentration in the nanotubes as determined by XPS was 0.4 atom percent. The platinum-sensitized, nitrogen-doped titania nanotube arrays annealed at 600° C. are hereinafter referred to as NT/Pt600.

### Example 1B

The procedure of example 1 was followed except that co-catalyst of Cu nanoparticles were deposited onto the annealed nitrogen-doped titania nanotube arrays by DC sputter deposition of copper nanoparticles (DC power 1.8 W/cm², pressure 20 mTorr, 5 cm distance between target and sample, deposition duration of 13 seconds). The copper-sensitized, nitrogen-doped titania nanotube arrays annealed at 600° C. are hereinafter referred to as NT/Cu600.

### Example 2

### Preparation of Annealed, Nitrogen-Doped Titania Nanotube Arrays Bearing Co-Catalysts of Platinum and Copper Nanoparticles

Nitrogen-doped, titania nanotubes were produced as in example 1 except that the nanotubes were annealed at 600° C. in air. Platinum nanoparticles then were DC sputter deposited onto one half of the nanotube array (top surface only, half of the macroscopic sample size). Copper nanoparticles were sputtered onto the other half of the nanotubes by DC sputter deposition. The resulting nanotubes bearing co-catalyst of platinum and copper are hereinafter referred to as NT/Cu/Pt/600.

### Example 3

### Photocatalytic Conversion of Carbon Dioxide to Hydrocarbons

Two, 2 cm×2 cm titanium substrates that bear 35 μm long NT/Pt600 nanotube arrays were each placed into a stainless steel reaction cell. The chambers were identical except that one chamber had a volume of 7.5 cm³ and the other chamber had a volume of 8.6 cm³. Each cell was equipped with valves for evacuation and for gas feeding and also included a side port with a septum for gas sampling and an O-ring sealed quartz window for admitting solar radiation.

A substrate was placed into each of the chambers to enable simultaneous exposure of the samples. The unexposed sides of the titanium substrates were masked with opaque adhesive tape. The substrates were secured to the interior of the chambers by copper tape so that the surfaces of the nanotube arrays face the quartz window for exposure to sunlight. The chambers then were evacuated to 10 mTorr using a mechanical pump and sealed.

Carbon dioxide (99.99% pure), via a mass flow controller (MKS instruments), was passed through a bubbler that contained de-ionized water to achieve a mixture of carbon dioxide and water vapor before entering the reaction chambers.

The chambers were flushed with the mixture of carbon dioxide and water vapor for ten minutes. Inlet and outlet valves to the chambers then were closed to maintain a nominal pressure of about 1.0 pounds per square inch in the chambers.

The nanotube arrays were then exposed to natural sunlight available under clear skies or under skies with a few clouds at University Park, Pa. (latitude 40° 49′ W and longitude 77° 51′ N) at an incident power density of 100 mW/cm². The equilibrium temperature of the arrays was 44° C.

The reaction products generated were analyzed using Shimadzu (GC-17A) gas chromatograph equipped with flame ionization (FI) and thermal conductivity (TC) detectors. Analysis of the reaction products shows predominately methane, with lower amounts of ethane, propane, butane, pentane and hexane as well as olefins and branched paraffins.

### Example 3A

The process of example 3 was employed except that 50 μm long NT/Cu600 arrays were employed and the nanotube arrays were exposed to natural sunlight for a rate-normalized duration of 1 hour at sunlight power density of 100 mW/cm².

The 50 μm long NT/Cu600 arrays were made by DC sputtering of Cu onto 50 μm long nitrogen-doped titania nanotubes. The 50 μm long nitrogen-doped titania nanotubes were made as in example 1 except that the anodization time was 12 hours.

### Example 3B

The process of example 3 was employed except that 70 μm NT/Pt460 arrays were employed and that the arrays were exposed to natural sunlight for a rate normalized duration of 1 hour and sunlight power density of 100 mW/cm².

FIG. 4 illustrates hydrocarbon generation rates for NT/Pt-600, 35 μm long), (NT/Cu-600, 50 μm long) and (NT/Pt-460, 70 μm long) arrays employed in examples 3, 3A and 3B. A hydrocarbon production rate of 104 ppm/cm²·hr (0.78 μl/cm²·hr) was obtained with NT/Cu-600, a rate of 82 ppm/cm²·hr was obtained with NT/Pt-600 and a rate of 61 ppm/cm²·hr with NT/Pt-460.

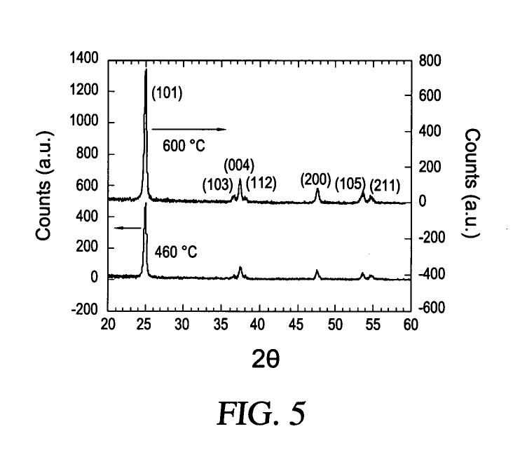

Crystallinity of the nanotubes was evaluated by x-ray diffraction analysis. As shown in FIG. 5, glancing angle x-ray diffraction patterns (GAXRD, Scintag x-ray diffractometer) of 60 μm long NT/Pt 460 and 60 μm long NT/Pt 600 arrays, recorded under identical instrument conditions, showed a higher crystallinity in NT/Pt 600.

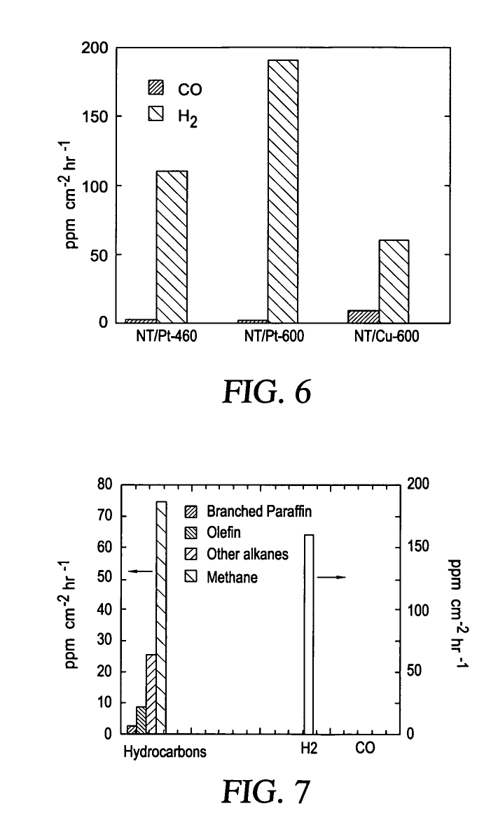

FIG. 6 illustrates the production rate of carbon monoxide and hydrogen during conversion of mixtures of carbon dioxide and water vapor. With NT/Pt type arrays, the H₂ generation rate exceeded the hydrocarbon rate. NT/Cu 600 arrays, however, generated about 500% more CO than either of the NT/Pt arrays shown in FIG. 6.

FIG. 7 illustrates the production rates of all the products for NT/Cu/Pt/600. The total production of hydrocarbons was 111 ppm/cm²·hr and for all the reaction products including hydrocarbons and hydrogen, 273 ppm/cm²·hr.

### Example 4

### Use of a High-Pass Filter (FSQ-GG400, Newport Corporation) to Remove the Ultraviolet Component of Sunlight During Photocatalytic Conversion

The procedure of example 1 was followed except that a high-pass filter (FSQ-GG400, Newport Corporation) was placed over the window of the reaction chambers to remove the ultraviolet component of sunlight.

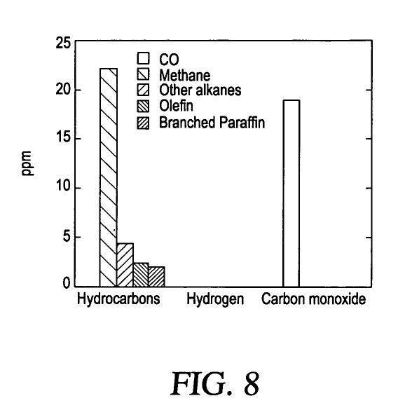

FIG. 8 shows the total yield of hydrocarbons obtained from a NT/Cu600 arrays of 50 μm length and 3.6 cm² area exposed to 78.5 W/cm² sunlight (measured filter output) for 3 hours.

What is claimed is:

1. A photocatalyst comprising,
a. a nitrogen-doped titania nanotube array of the formula TiNₓO₂₋ₓ wherein 0≦x≦1; and,
b. nanoparticles of one or more co-catalysts on one or more surfaces of the nitrogen-doped titania nanotubes wherein the co-catalyst is selected from the group consisting of Ag, As, Au, Bi, Cd, Co, Cu, CuO, Cu₂O, Fe, Ga, Ge, In, Ir, Ni, Pb, Pd, Pt, Rh, Sb, Si, Sn, Ta, Tl, W, Zn or mixtures thereof.

2. A method for forming nitrogen-doped titania nanotubes comprising:
anodizing a substrate comprising titanium in an electrolyte comprising a fluoride ion source, a chloride ion source, or combinations thereof and a nitrogen source to form an array of nitrogen-doped titania nanotubes; and
heating the nitrogen-doped titania nanotube array to increase the crystallinity of the nitrogen-doped titania nanotube array; and,
depositing nanoparticles of a co-catalyst selected from the group consisting of Ag, As, Au, Bi, Cd, Co, Cu, CuO, Cu₂O, Fe, Ga, Ge, In, Ir, Ni, Pb, Pd, Pt, Rh, Sb, Si, Sn, Ta, Ti, W, Zn or mixtures thereof on one or more surfaces of the nitrogen-doped titania nanotube array.

3. The method of claim 2, wherein the nitrogen-doped titania nanotube array has a formula of TiNₓO₂₋ₓ wherein 0≦x≦1.

4. The method of claim 2, wherein the electrolyte comprises ethylene glycol, ammonium fluoride and water.

5. The method of claim 2, wherein the heating of the array is performed at a temperature of about 280° C. to about 700° C. for a time period of about 0.5 hours to about 8 hours.

6. The method of claim 2, wherein the substrate further comprises one or more metals, metal oxides or mixtures thereof selected from a group consisting of Ag, As, Au, Bi, Cd, Co, Cu, CuO, Cu₂O, Fe, Ga, Ge, In, Ir, Ni, Pb, Pd, Pt, Rh, Sb, Si, Sn, Ta, Tl, W, Zn, or mixtures thereof, and wherein the nanotube array has a formula of Ti_{1-y}M_{y}O₂ where 0≦y≦1 and M is selected from a group consisting of Ag, As, Au, Bi, Cd, Co, Cu, CuO, Cu₂O, Fe, Ga, Ge, In, Ir, Ni, Pb, Pd, Pt, Rh, Sb, Si, Sn, Ta, Tl, W, Zn, or mixtures thereof.

7. The method of claim 2, wherein the nitrogen-doped titania nanotubes are co-doped with one or more nonmetals selected from the group consisting of B, C, F, I, P, S or mixtures thereof.

8. A method for photocatalytically converting carbon dioxide into reaction products comprising any one or more of hydrocarbons and hydrocarbon-containing products, hydrogen and hydrogen-containing products, carbon monoxide and carbon-containing products, or combinations thereof, comprising:
a. exposing a reactant gas comprising carbon dioxide to a photocatalyst and electromagnetic radiation to generate the reaction products;
b. wherein the photocatalyst is a nitrogen-doped titania nanotube array of the formula TiNₓO₂₋ₓ wherein 0≦x≦1; and,
c. wherein nanoparticles of one or more co-catalysts are present on one or more surfaces of the nitrogen-doped titania nanotubes wherein the co-catalyst is selected from the group consisting of Ag, As, Au, Bi, Cd, Co, Cu, CuO, Cu₂O, Fe, Ga, Ge, In, Ir, Ni, Pb, Pd, Pt, Rh, Sb, Si, Sn, Ta, Ti, W, Zn, or mixtures thereof.

9. The method of claim 8, wherein the reactant gas comprising carbon dioxide is selected from the group of reactant gases consisting of carbon dioxide alone, or mixtures of carbon dioxide and hydrogen-containing gases.

10. The method of claim 8, where the electromagnetic radiation comprises ultraviolet, visible, infrared radiation, or any combination thereof.

11. The method of claim 8, wherein the nitrogen-doped titania nanotube array comprises a titanium compound of the formula Ti_{1-y}M_{y}O₂ where 0≦y≦1 and M is selected from a group consisting of Ag, As, Au, Bi, Cd, Co, Cu, CuO, Cu₂O, Fe, Ga, Ge, In, Ir, Ni, Pb, Pd, Pt, Rh, Sb, Si, Sn, Ta, Tl, W, Zn, or mixtures thereof.

12. The method of claim 8, wherein the nanotube photocatalyst is in the form of a closed end type nanotube array, an open-ended flow-through type nanotube array, or combinations thereof.

13. A method for photocatalytically converting carbon dioxide into reaction products comprising any one or more of hydrocarbons and hydrocarbon-containing products, hydrogen and hydrogen-containing products, carbon monoxide and other carbon-containing products, or combinations thereof, comprising:
a. exposing a reactant gas comprising carbon dioxide to a photocatalyst and electromagnetic radiation to generate the reaction products;
b. wherein the photocatalyst comprises any one of TiNₓO₂₋ₓ where 0≦x≦1, Ti_{1-y}M_{y}O₂ wherein 0≦y≦1 and mixtures thereof,
c. wherein nanoparticles of one or more co-catalysts are present on one or more surfaces of the nitrogen-doped titania nanotubes wherein the co-catalyst is selected from the group consisting of Ag, As, Au, Bi, Cd, Co, Cu, CuO, Cu₂O, Fe, Ga, Ge, In, Ir, Ni, Pb, Pd, Pt, Rh, Sb, Si, Sn, Ta, Ti, W, Zn, or mixtures thereof.

14. The method of claim 13 where M is Cu.

15. The photocatalyst of claim 1 wherein the nitrogen-doped titania nanotubes are co-doped with one or more nonmetals selected from the group consisting of B, C, F, I, P, S or mixtures thereof.
